(19) United States
(12) Patent Application Publication
(10) Pub. No.: US 2020/0178632 A1
(43) Pub. Date: Jun. 11, 2020

(54) AUTOMATED CONTROL AND INSPECTION SYSTEM FOR MANUFACTURE AND MEASUREMENT OF APPAREL

(71) Applicant: VF Jeanswear Limited Partnership, Greensboro, NC (US)

(72) Inventors: Dhruv Agarwal, Greensboro, NC (US); Phillip F. Aydeiette, Oak Ridge, NC (US); James Francis Brennan, Austin, TX (US); Matthew Anthony Pooley, Croton-on-Hudson, NY (US); Erwin Kin-Ping Lau, Fremont, CA (US)

(73) Assignee: VF Jeanswear Limited Partnership, Greensboro, NC (US)

(21) Appl. No.: 16/642,536

(22) PCT Filed: Aug. 30, 2018
(86) PCT No.: PCT/US2018/048827

§ 371 Date: Feb. 27, 2020

Related U.S. Application Data
(60) Provisional application No. 62/552,064, filed on Aug. 30, 2017.

(51) Int. Cl. A41H 3/00; A41H 3/04; A41H 1/02; D06H 3/16; D06H 3/08; G01N 21/95

(52) U.S. Cl. CPC A41H 3/007; A41H 3/04; A41H 1/02; G01N 2021/8829; D06H 3/08; G01N 21/9515; G06T 2207/10016; D06H 3/16

(57) ABSTRACT

An automated control apparatus, method, and system for improving inspection, measurement, and fabrication of apparel is described. The system is used to capture an image of the apparel or apparel-related object and convert that image into a digital representation which can then be sent to and stored in a database to be used to recreate ideal apparel with reproducible measurements and patterns. The system also allows for comparisons with already existing ideal images and/or the apparel itself to determine if the apparel or apparel-related object possess the correct dimensions, shapes, colors, textures and fabrics, etc.

### CROSS REFERENCE TO RELATED APPLICATION

This application claims the benefit of U.S. Provisional Application No. 62/552,064, filed Aug. 30, 2017, which is herein incorporated by reference in its entirety.

### FIELD OF THE INVENTION

The present disclosure involves systems, devices, and methods associated with the control of measurement and inspection for apparel and apparel-related objects that ensures obtaining proper dimensional analysis. More specifically, the disclosure is directed to a system that automatically measures physical dimensions of these objects by reducing or eliminating the need for direct contact by humans of the objects in order to achieve a desired set of criteria. In general, in-lieu of handling or otherwise touching/contacting of the objects, it is necessary to externally acquire, digitize, and store data directly from either the actual physical dimensions of the object itself or from images obtained of the object(s). This data can then be manipulated, as required, in order to extract information or measurement values such as; lengths, angles, areas, volumes, coordinates, as well as measurements of other physical dimensions and geometric quantities. This data may also be manipulated in order to extract other information or measurement values, including: surface texture, color, transparency, reflectivity, thermal or radiative emittance, and other properties associated with fabric used to manufacture the apparel. The information in the form of data acquired can be used for comparison with an ideal set of data; labeling or categorizing garments according to any of the extracted value of the properties, including physical dimensions, color; and/or for quality control purposes.

### BACKGROUND

Over the centuries, numerous techniques have evolved for measuring physical dimensions of objects involving apparel, which can be made for wearing by humans, their domesticated animals and pets, dolls, or furnishings, or other purposes where fabric or otherwise flexible coverings are desired. The most common manual technique provides taking certain measurements utilizing devices such as tape measures, rulers, laser distance tools, or some other technique for acquiring the linear distance between two points where the locations of the points are identified by a human. Frequently, these measurement techniques are time consuming, often requiring manual manipulation of the apparel such as performing particular folding, and can be difficult or impossible to provide based on location and proximity constraints. Furthermore, this measurement technique often does not yield accurate, precise, and/or reproducible results, with human error normally associated with the dominant source of error causing unacceptable results. Measurement becomes an increasingly tedious repetitive task when performed by humans for long periods of time and/or for generally the same apparel.

Several mechanical methods have also been developed and used to make these type of measurements. One common method is a “sliding gauge method” that uses a multiplicity of parallel sliding bars each arranged perpendicular to a reference plane. These bars are placed directly in contact with the object being measured in locations that are selected by human operators of the equipment. The linear distance between two selected points can be obtained using the distance between two bars in the reference plane, along with distances that the two bars protrude from the reference plane when in direct contact with the object being measured: for example, using a three dimensional Euclidean coordinate system, the x- and y-coordinates of each point may be determined by the location of the corresponding bar in the reference plane and the z-coordinate may be determined by the perpendicular distance from the reference plane that the corresponding bar protrudes when in contact with the object being measured. Pythagorean or other geometric techniques, may then be used to calculate the linear distance between two selected points. This method exhibits certain disadvantages, including the fact this method requires human identification and selection of the points included in measurements; human manipulation and positioning of the bars; and that the bars are required to come into direct contact with the object being measured. Human intervention is usually undesirable because this normally increases the expense and reduces the accuracy and/or reproducibility of measurements associated with human error. In addition, for apparel, and especially garments, such as pants, shirts, socks, coats, etc., which are often irregularly shaped, flexible, etc., or for measurements of other flexible or otherwise deformable objects, the object may be perturbed by the bars leading to a reduction in accuracy of measurements. Furthermore, linear measurements of distances between points may not be practical for extracting measurements of surface area, surface distance along an undulating plane, or of cavity volumes. For example, using such linear measurements, it may not be convenient to measure the surface area or interior volume of a leg of a pair of pants. In order to achieve the accuracy of such an area or volume measurements within a reasonable tolerance, using linear point-to-point measurements often requires a large and cumbersome number of linear distance measurements.

Previous techniques such as taught and described in U.S. Pat. No. 5,530,652, have proposed utilizing machine vision consisting of acquiring a multiplicity of images of the object and processing them to produce a 3-dimensional wire-frame representation for later processing, i.e. optical triangulation techniques to obtain image topography. One aspect of their invention includes an object such as a manufactured pair of pants and using compressed air to inflate and expand the pants during measurements. Unfortunately, optical triangulation methods have been unable to achieve the measurement accuracy needed in a garment manufacturing environment. One challenge includes working within that environment's limitations of available space, processing time, and the ability to enable system robustness within that environment. The challenges have been further increased by the need for a rigid garment mounting system that can accommodate varying garment sizes, yet not allow sagging, crumpling, movement or vibrations of the object during the entire measurement process. An automated garment measurement system with proper mounting apparatus is not known to exist for at least some of the reasons stated here, yet the need for an automated system remains. These and other shortcomings of the art may be addressed by the present disclosure.

### SUMMARY

An automated inspection and measurement control system that is used to inspect, measure, and ensure proper fabrication of many types of apparel is described. The system has been developed to include garments, including pants, shorts, shirts, shoes, hats, gloves, etc. using signals to acquire dimensional scan-data representative of necessary physical dimensions. The scan-data is collected by scanner equipment, which may be operated by one or more computer systems used to provide an automated control system. The control system aids in determining additional specific parameters and associated properties of the apparel being inspected, measured and/or fabricated.

More specifically, this disclosure describes an apparatus for measurement, inspection, and quality control during fabrication of apparel and apparel-related objects comprising:

(i) mounting equipment arranged to provide for full and unimpeded access of signals directed from any direction toward or away from the apparel and apparel-related objects;

(ii) scanning equipment that comprises any combination from the group consisting of optical, mechanical, and electrical scanning devices that scan the apparel mounted on the mounting equipment,

(iii) computer equipment (e.g., or a computing system) capable of control of mounting and scanning equipment
and wherein;
the scanning equipment generates scan-data comprising signals obtained from the scanning devices such that the scan-data is either sent or retrieved directly from the scanning devices and is stored and retrieved in and from one or more data storage devices that reside on or in the computer equipment that provides for recognition, storage, and analysis of the scan-data wherein the computer equipment includes scan-data storage, transmission, and analysis capabilities; and;
wherein the scan-data contains and provides information necessary to determine and control complete inspection and fabrication to reduce or eliminate quality defects including unacceptable variations selected from the group consisting of stitching, breaks or changes in color, fabric patterns, shades, tears, unwanted marks, and blemishes, and/or during fabrication of the apparel.

In some or all cases, data storage devices can be databases. The scan-data is digital data from signals generated using any form of energy selected from the group consisting of electrical, optical, mechanical, electromagnetic, and electro-mechanical, energy.

The scan-data may be sent indirectly from scanning devices through one or more converters that convert electrical optical and/or mechanical data into digital data.

Specific information regarding the apparel and apparel-related objects contained within the scan-data is selected from any combination of the group consisting of videos, photos, and point-cloud imaging, wherein the imaging provides parameters without distortion necessary to ensure automated manufacture, reproduction, quality control, and statistical analysis of the apparel.

The parameters are measurements without distortion selected from at least the group consisting of one or more of the following; dimensional shape, length, area, volume, diameter, circumference, lengths, area, surface texture, stretchiness, transparency, reflectivity, thermal transmittance, radiative transmittance, color, shades, fabric type, and/or texture, and wherein the scan-data is received, stored, and analyzed to achieve automated manufacture, reproduction and quality control of the apparel such that associated labeling and/or categorization occurs.

The scan-data can include information obtained from items selected from a group consisting of markers, pins, bar codes, IR codes, QR codes, and RFID tags.

The computer equipment includes a server, wherein the server sends, stores and retrieves scan-data from and to a cloud-server. Additionally, the computer equipment operates dependently and includes one or more computers capable of accessing one or more internet or intranet networks. Also, the computer equipment includes one or more computers independently capable of retrieval, storage, and analysis of the scan-data and wherein the computer equipment provides at least one user interface to enable observation of scans during scanning that provides and allows for control of progression of scan-data.

The computer equipment may also be networkable through use of a client-server and can operate as an enterprise network either independently, via an intranet, and/or via an internet including the world-wide-web. The scan-data may also be transmitted as uninterrupted (and possibly) streaming data. The scan-data is capable of being stored and retrieved from a database, in that the scan-data is utilized to recreate images of the apparel in order to inspect, measure, and/or fabricate the apparel upon demand.

In another embodiment, the apparatus is dynamic in that the apparatus moves during scanning and transmitting of the data obtained from the apparel to the computer equipment.

It is also instructive to provide scanning equipment and devices which include programmable robots that take instructional information from software that accesses and interprets the data residing in on or more databases and wherein the robots act upon instructions from instructional information to perform inspection, dimensional analysis, sizing, and fabrication operations.

The apparel can be fabricated in an accurate, precise, and reproducible manner from robots utilizing the data.

Further to the system already described, the mounting equipment further comprises mounting stations designed specifically to hold the apparel such that the features are readily scanned using the scanning devices to ensure that the data comprises information that is complete in that it provides accurate, precise, and reproducible images and associated information regarding the apparel.

The mounting station is static when used in conjunction with a dynamic apparatus in that the apparatus moves to ensure complete scans during scanning and transmitting of the data obtained from the apparel.

Alternatively or correspondingly, the mounting station is dynamic in that the mounting station moves to ensure complete scans during the scanning and transmitting of the data obtained from the apparel.

The apparatus utilizes a lighting technology selected from the group consisting of one or any combination of structured light, laser light, pulsed light, continuous wave light, modulated light, that is transmitted and received from features existing on the mounting station, on the apparel, or on a combination of the mounting station and the apparel.

The apparatus is automatically controlled either remotely or directly by the computer equipment with or without human intervention, and wherein automatic control allows for increased speed and efficiency during fabrication of the apparel.

Here, the apparel comprises garments that further comprise articles of clothing wherein the articles of clothing are selected from the group consisting of but not limited to pants, bags, jackets, shirts, undergarments, shoes, hats, coats, socks, and slippers.

The apparatus is used to create a 2-D or 3-D representation to fabricate individualized or tailor-made clothing and wherein direct shipping via automatic control of fabrication is accomplished.

An apparatus may be provided that compares an object of a specified size to determine if dimensions of that object are within a predetermined tolerance of an ideal standard, further comprising imaging the object by scanning and determination of a plurality of dimensions associated with the object and using scan-data to compare that scan-data with an ideal object; and comparing dimensions of the object to standard dimensions for determining whether scanning dimensions of the object are within an allowable tolerance.

The scan-data is obtained by fixing the object to a rotating mounting station, rotating the mounting station relative to an axis of rotation and capturing a plurality of images of the object such that each image can be captured from a distinct vantage point, and wherein the rotating mounting station is equipped such that the apparel is placed on a mount configured appropriately so that the apparel assumes a desired shape and the mounting station is subsequently rotated to ensure full image capture is obtained.

In addition, one or more scans of the object provides complete scans by fixing the object to the mounting station and rotating a plurality of image capturing devices relative to the object and relative to an axis of rotation.

Complete scans are created by fixing the object to a rotating mounting station and rotating the mounting station so that a plurality of image capturing devices relative to each other and relative to an axis of rotation provide scan-data.

Complete scans of the object are created by fixing the object to the mounting station and positioning a plurality of devices selected from any one or combination of the group consisting of: mirrors, cameras, and other optical or electro-optical devices around or on the mounting station, such that each of the devices are positioned at a distinct vantage point, thereby providing multiple image capturing devices in order to capture at least one scanned image of the object from each device during scanning and generating scan-data.

In a similar embodiment, a method for complete inspection, measurement, fabrication, and quality control of apparel is described wherein the method comprises;

a) mounting the apparel using mounting equipment such that all features of the apparel are accessible and unimpeded by scanning equipment;

b) providing and enabling the scanning equipment in combination with the mounting equipment such that the scanning equipment is electrical, mechanical, optical, electromechanical, and/or electro-magnetic, and is capable of providing scanning of the apparel thereby sending signals that comprise a form of scan-data utilized by one or more data storage devices residing within one or more computer systems;

c) organizing, storing, and retrieving the scan-data in order to develop accurate, precise, and reproducible images of the apparel;

d) finalizing the method by providing information using a computer system (e.g., computerized control system) capable of generating output comprising apparel inspection, measurements, and categorization of the scan-data.

Again, the data storage devices can be and often are databases.

The method further provides a feedback loop so that scan-data can be generated on a continuous basis and is being utilized to assure iteration toward achieving dimensional measurements that are identical or nearly identical to an ideal piece of apparel.

As before, the computer system is networkable through use of a client-server and is operating as a network via an intranet, and/or via an internet including accessing and utilizing a world-wide-web.

Scanning equipment includes devices that are programmable robots taking instructional information from software that is accessing and interpreting the scan-data residing in or on or more databases and wherein the robots are acting upon instructions from the instructional information to perform inspection, dimensional analysis, sizing, and fabrication operations on demand.

Dimensional measurement information is obtained from scan-data being transmitted in a form of digital imaging signals from scanning equipment to one or more computer systems during scanning of distinct features. The features can be mounted directly to a portion of the apparel and/or to a mounting station holding the apparel.

The scan-data can be transmitted as interrupted data which may be streaming data wherein the scan-data is being stored and retrieved from a relational database, in that the data is utilized for organizing the scan-data and is being utilized to recreate images of the apparel for inspecting, measuring, fabricating, and reproducing the apparel upon demand.

The mounting equipment further comprises one or more mounting stations designed specifically for holding the apparel such that features are scanned using the scanning equipment and ensuring scan-data comprises information that is complete in that it is provides accurate, precise, and reproducible images and associated information specific to the apparel.

Here, the apparel is fabricated in an accurate, precise, and reproducible manner from robots utilizing scan-data. The method is dynamic in that the apparatus moves during scanning and transmitting of the scan-data obtained from the apparel by the computer systems.

The mounting stations are static when being used in combination with dynamic apparatus in that the apparatus is moving thereby ensuring complete dimensional scans during scanning and transmitting of the scan-data obtained from the apparel. Further, the mounting stations are dynamic in that the mounting stations are moving to ensure completing these dimensional scans during scanning and transmitting of data obtained from said apparel.

The method is capable of utilizing a form of light selected from one or more of the group consisting of: structured light, laser light, pulsed light, modulated light, continuous wave light, and streaming light transmitted and received from features existing on said mounting station, on the apparel, or on a combination of the mounting station and the apparel.

The apparatus is automatically controlled either remotely or directly by the computer systems with or without human intervention. Lidar is another technique that can be used for scanning the objects.

The method utilizes apparatus comparing an object of a specified size to determine if dimensions of that object are within a determined tolerance of a standard, further comprising: imaging the object by scanning and determining a plurality of dimensions of the object using scan-data to compare that scan-data with an ideal object and comparing dimensions of the object to standards for determining whether scan-data dimensions of the object are within an allowable tolerance.

Scan-data is obtained by fixing the object to a rotating mounting station and rotating the mounting station relative to an axis of rotation and capturing a plurality of images of the object. Each image can be captured from a distinct vantage point. The rotating mounting station is equipped such that the apparel is placed on a mount and inflated with gas so that the apparel assumes its natural shape and the mounting station is subsequently rotated to ensure full image capture is obtained and resides in the scan-data.

Scanning the object provides complete scans by fixing the object to the mounting station and rotating a plurality of image capturing devices relative to the object and relative to an axis of rotation.

Complete scans are created by fixing the object to a rotating mounting station and rotating the mounting station and a plurality of image capturing devices relative to each other and relative to an axis of rotation.

Scans of an object are being created by fixing the object to a mounting station and positioning a plurality of devices selected from one or more of the group consisting of mirrors, cameras, and other electrical, mechanical, optical, electro-mechanical, and/or electromagnetic devices around the mounting station such that each of the devices is positioned at a distinct vantage point, thereby providing multiple image capturing devices in order to capture a scanned image of the object from each device during scanning and generating scan-data.

Another embodiment includes a system for measurement, inspection, and quality control during fabrication of apparel and apparel-related objects comprising:

(i) mounting equipment arranged to provide for full and unimpeded access of signals directed from any direction toward or away from the apparel and apparel-related objects;

(ii) scanning equipment that comprises any combination from the group consisting of optical, mechanical, and electrical scanning devices that scan apparel mounted on the mounting equipment,

(iii) computer equipment capable of control of the mounting and scanning equipment

(iv) and wherein

(v) the scanning equipment generates scan-data comprising signals obtained from the scanning devices such that the scan-data is either sent or retrieved directly from the scanning devices and is stored and retrieved in and from one or more storage devices that reside on or in the computer equipment capable of recognition, storage, and analysis of the scan-data wherein the computer equipment includes scan-data storage, transmission, and analysis capabilities;

(vi) and wherein the scan-data contains and provides information necessary to control and complete inspection, measurement, and/or fabrication of the apparel.

The scan-data is digital data from signals generated using any form of energy selected from the group consisting of electrical, mechanical, optical, electro-mechanical, and electromagnetic energy. The scan-data can be sent indirectly or directly from scanning devices through one or more converters that converts electrical optical and/or mechanical data into digital data.

Specific information regarding the apparel and apparel-related objects contained within the scan-data is selected from any one or a combination of the group consisting of video, photo, emissivity, and point-cloud imaging, wherein the point-cloud imaging provides parameters necessary to ensure automated manufacture, reproduction, and quality control of the apparel.

Here, parameters are measurements selected from at least the group consisting of one or more of the following; dimensional shape, volume, diameter, circumference, shape, shades, color, fabric type and/or texture and wherein the scan-data is received, stored and analyzed as required to achieve automated manufacture, reproduction, and quality control of the apparel.

The scan-data is obtained from dimensional scan generated data.

The computer equipment includes a server, wherein the server sends, stores and retrieves scan-data from and to a cloud-server.

The computer equipment operates dependently and includes one or more computers capable of accessing one or more internet or intranet networks.

The computer equipment includes one or more computers independently capable of retrieval, storage, and analysis of scan-data.

In another embodiment a system comprising scanning equipment and electrical, mechanical, optical, electro-mechanical and/or electromagnetic devices that scan apparel, wherein scanning generates scan-data obtained from optical and/or electro-optical scanning devices, and wherein scan-data is digital and stored and retrieved in and from one or more data storage devices (including databases) capable of recognizing digital data that resides on a computer system.

The computer system includes storage and transmission capable of scanning data and the scan-data contains and provides information necessary to complete inspection, measurement, fabrication, quality control, and proper fit of the apparel, wherein the system further comprises;

a) mounting said apparel such that all features of said apparel are accessible by the scanning equipment, including when the apparel is provided in a laid flat position;

b) acquiring and utilizing the scanning equipment, wherein the scanning equipment is also electrical, mechanical, optical, electro-mechanical, and/or electromagnetic and is capable of providing scanning of the apparel thereby sending signals that provide scan-data to one or more databases residing within one or more computer systems;

c) organizing, storing, retrieving, and analyzing the data in order to develop accurate, precise, and reproducible images of the apparel;

d) finalizing the system by providing said information using a computer system generating signals that forms the scan-data wherein the scan-data comprises information including apparel inspection, measurements, and categorization.

The system further comprises providing a feedback loop so that the scan-data is generated on a continuous basis and is being utilized to assure iteration toward achieving dimensional measurements are identical or nearly identical to that of an ideal apparel or apparel-related object.

### BRIEF DESCRIPTION OF THE DRAWINGS

FIG. 1 is a flow diagram representing the various stages of an automated three-dimensional controlled inspection, measurement, and fabrication apparel system that provides for manufacture of one or more precisely sized garments or wearable accessories.

FIG. 1A provides more detailed information, suitable for use in the preferred embodiment, for each of the various stages in FIG. 1.

FIG. 2 illustrates one embodiment of a mounting apparatus of the disclosure.

FIG. 3 illustrates another embodiment of a mounting apparatus of the disclosure featuring multiple mounting positions.

FIG. 4 illustrates yet another embodiment of the mounting and optical scanning apparatus of the disclosure.

FIG. 5 is a flow diagram representing various stages of processing for application to optically acquired scan-data in one embodiment.

### DETAILED DESCRIPTION

Methods, systems, and apparatuses of the present disclosure may address and overcome certain disadvantages in the art. More specifically, the present techniques, methods, devices, and apparatus, may be configured to acquire data representative of physical dimensions, or other desired properties, of apparel; and may be configured to manipulate, or otherwise process the data. The data may contain information in order to extract a desired set of physical dimensions. Other properties of the apparel that can be acquired include techniques, methods, devices, and apparatus to be configured such that human error in measurements is minimized. The automated system is configured such that accurate measurements are obtained in a typical factory setting without the need for careful calibration of each measurement. It is also desirable to provide a mounting apparatus that does not have to be customized for each individual style/variant of garment.

Specific terms in the present specification have been provided more specific meaning as follows:

The term “three-dimensional data” refers to data that contains information regarding the shape, dimensions, orientation, or other physical property of an object that includes location, position, or geometric information described in a coordinate system with at least three-dimensions.

The term “scanning” describes any metrology process by which three-dimensional data representative of the object being “scanned” is acquired. Modifications to the term “scanning” may be used to further restrict the means by which scanning is achieved, for example “optical scanning” restricts scanning to require the use of optical signals. Although certain scanning may require obtaining three-dimensional data, this may be achieved in some examples by a system that acquires more than one two-dimensional image before combining and processing these images to extract three-dimensional data from the imaged object or scene.

The term “scan-data” refers to data acquired by scanning, regardless of the exact methodology by which it is acquired. Scan-data, by definition, includes information representative of the three-dimensional geometry of scanned object, and may in addition include any other data acquired during scanning.

The term “object-information” describes information derived from scan-data via application of any processing to said scan-data. Object-information may include physical parameters, such as dimensions, areas, volumes, feature locations, or the like; or may also include any surface properties, such as texture, color, patterns, or the like; or a combination of physical parameters and surface properties.

The term “meshing” refers to a process by which a continuous surface is generated from a set of distinct coordinates. This process is familiar to one of skill in the art of computer graphics or computer modelling of geometry, however this definition is included for clarity for the elimination of potential ambiguity. The resulting “mesh” is usually composed of adjoined polygons that approximate the form of a surface that encompasses the coordinates as closely as possible. For example, a set of coordinates obtained from the surface of a sphere via scanning may be meshed to generate a mesh comprised of adjoined triangles, of various sizes, that approximate a spherical surface within a resolution determined by the minimum size of the triangles. The set of coordinates is then referred to as having been “meshed.”

The term “point cloud” describes a collection of points, each of which is associated with the x-, y-, and z-coordinate of a given point on the surface of the object being measured. Collectively, a point cloud at least provides a representation of the object that has been scanned by providing coordinates that define the surfaces of the object.

In order to meet the needs described above, this disclosure generally provides techniques used to obtain three-dimensional data, referred to as “scan-data” and defined above. Scan-data may be processed or otherwise manipulated to obtain “object-information,” as defined above, which comprises quantifiable and qualitative parameters such as values, metrics and are used to assess the quality of the scanned object.

These quantifiable/qualitative parameters include: physical dimensions; the location and arrangement of specific dimensional features; the number of these features; color; surface textures, optical properties including transmittance, reflectance, and emittance; and, other surface qualities including weave or stitching quality.

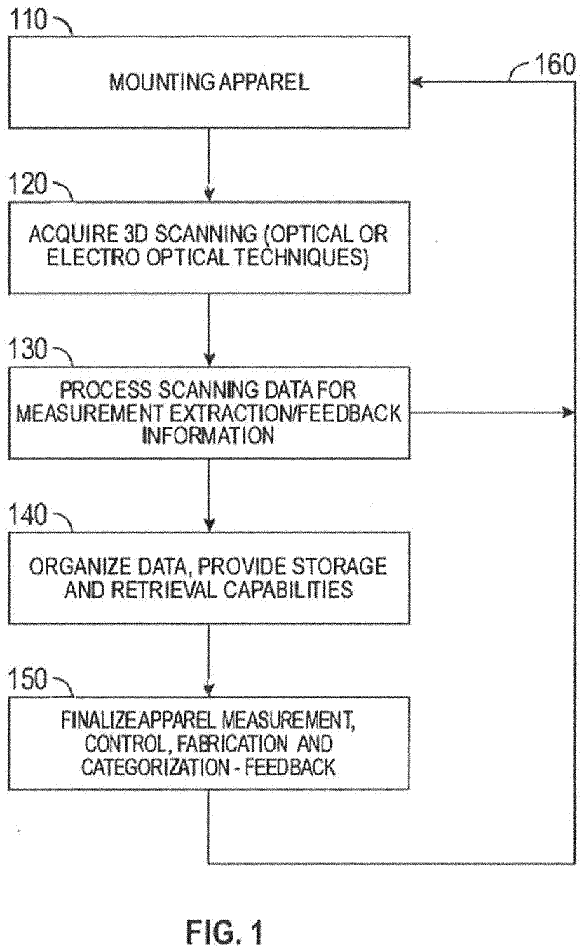

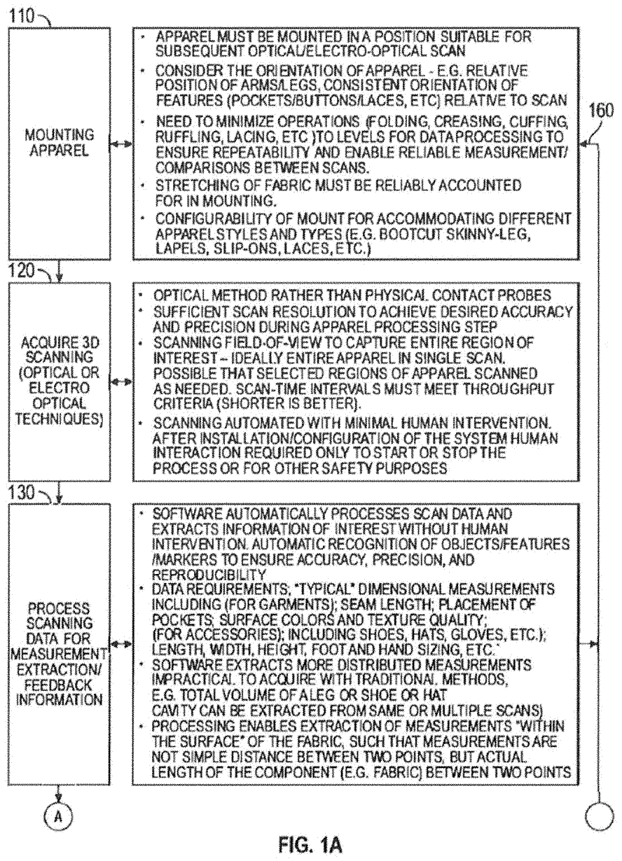

Several aspects relating to mounting, scanning, and processing of scan-data to obtain object-information, and application of scan-data are detailed below. In general, an overview of how these aspects are accomplished is represented in FIG. 1. The apparel, such as a garment, may be properly mounted (110) such that it is positioned properly in order to provide a reliable and reproducible optical scan. The precise mounting configuration is dependent upon the particular garment being scanned and on the specific information that is to be extracted from the garment. Preferably, a single mounting apparatus is configured or otherwise adapted to accommodate a wide range of garments for a wide range of scans that removes the need to create mounting apparatus specific to a particular garment, variant, or style. Also, preferably the mounting apparatus incorporates actuators and sensors to enable active control of the garment configuration during optical scanning. Scan-data is then acquired (120) via optical means. Relative motion between the scanning device and the apparel is used to enable the full 3D surface of the apparel to be scanned. Alternately, multiple imaging devices are used to simultaneously acquire full 3D surface properties of the apparel. In addition, if information regarding only a selected region of the apparel is desired, scanning can be performed on specific regions. The scan-data is processed in order to object-information (120), which contains predetermined values, properties, parameters, or other figures-of-merit that are extracted from the scan-data. Scan-data or object-information, or both, may be stored (140) that enables later retrieval and to create an organized record of acquired data. The scan-data, object-information, or both, may then be used for the intended purpose (150), such as quality control purposes, or categorization or labeling of apparel according to data obtained via optical scanning. Optionally, the scan-data, object-information, or both, provide signals that are input into a feedback loop for the system. This feedback loop enables active optimization of manufacturing parameters required to perform the measurement of the apparel.

Mounting

A mounting system upon which an object is mounted or positioned as scan-data is acquired, may be provided. The quality of scan-data, and the most suitable scanning method, is selected in conjunction with the mounting system to ensure that the overall system functions as required. Generally, an appropriate mounting system may enable acquisition of full and complete scan-data for a given object. A mounting system is determined by specific features of the object being measured. For example, if the object being measured is a garment, such as a pair of jeans, the mounting system may be designed to prevent excessive crumpling or folding that inhibits the scanning by obscuring portions of the garment surface from the scanning apparatus. The mounting system may also be able to accommodate a range of garment sizes and position the garment in a stationary position for examination.

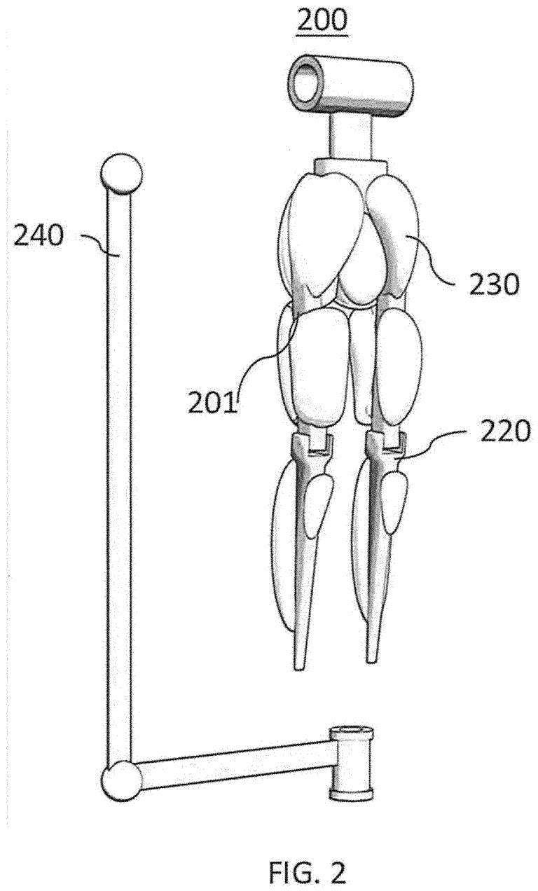

The mounting techniques employed include the use of rod systems that move/expand/unfurl after mounting to configure and spread or otherwise properly expand the apparel/garment, and inflatable bladder systems that enable different regions of the apparel (clothing, garments, etc.) expanded for different sizes. The mounting system is also designed to facilitate convenient mounting and unmounting of garments by adopting a configuration in which garments may be placed on, or removed from, the system easily. For example, FIG. 2 is representative of one embodiment, where a rod and bladder system is utilized for pant garments. Positioning the rods enables the configuration of the pant legs to be controlled, and inflation of the bladders enables the leg cavities to be filled with gas or air. The size and pressure to which the bladders are inflated can enable accommodation of various sizes and cuts/styles of pants without modification of the mounting system, and when suitably inflated, the bladders prevent wrinkles, folding, etc. When the bladders are deflated and the rods position the legs straight and parallel to each other, the pants can be conveniently mounted or unmounted from the system. This mounting system overcomes several shortcomings regarding existing mounting solutions. For example, mannequins are often employed to mount garments, however mannequins cannot be dynamically adjusted to accommodate different garment sizes or styles. Also, systems of rods used in earlier mounting systems, utilize inflation of entire garments, or cavities thereof, via compressed gas provided directly into the garment. In this situation, no mechanisms are provided for holding the resulting inflated garments in a stationary position, or for configuring the garment(s) in a predetermined position. The use of inflatable bladders disclosed herein overcomes these shortcomings.

Additional features of the mounting portion of the system includes reference markers for use with automatic data processing.

One example includes employing objects that protrude from the specific garment area used by the scanner that can include a computerized buffering system together with processing software to assist with orientating the scan. These include utilizing calibrated objects of known size and shape, including spheres of known radius or rods of known length, which allows the software to calibrate distances from, or relative orientations in relation to, the garment. In addition, these calibration techniques can also include areas of known surface properties, e.g. color/texture/reflectivity/etc., to aid in calibrating scan-data. More specifically, in reference to FIG. 1A, the apparel may be mounted (110) in a position suitable for subsequent optical scanning with consideration given to orientation of the apparel and the pose in which it is configured. There is a need for the mounting system to minimize manual handling that is required prior to or during mounting. For example, the mounting system may allow for rapid mounting and unmounting without the need for careful alignment or placement of the apparel, and without the need for folding or otherwise manually manipulating the apparel into a specific configuration prior to mounting. Once apparel is mounted, the mounting system may be adaptable so that the mounting system can move and configure the apparel into the desired configuration for scanning. In addition, the mounting system may hold the apparel stationary in this configuration for the duration of the optical scanning session. The mounting system may also be able to accommodate a multitude of different apparel items, styles, cuts, or configurations, so that “bespoke” mounting systems are not required for a particular apparel item. Here “bespoke” refers to the fact that a different and unique mounting system is not required for each particular mounting system.

Furthermore, markers can be placed in predetermined locations upon an item of apparel prior to scanning to aid in automatic detection of specific apparel features. For example, stickers can be affixed before or after mounting to provide an easily detectable feature for use in further processing. Alternately, dyes or inks that are visible only to the optical scanning equipment, and not to human eyes, are used for the purpose of making useful features for scanning/processing of scan-data. More than one mounting position enables multiple garments be mounted simultaneously.

With reference to FIG. 2, one embodiment of a mounting apparatus comprises a system of rods (201), hinged joints (220), and inflatable bladders (230) that collapse to enable a pair of jeans to be easily mounted and then expanded to support the jeans in a predetermined configuration. This embodiment of a mounting apparatus also provides calibration objects (240), which include rods and spheres of known size and orientation, that are included in scan-data for use in subsequent data processing. The overall shape, orientation, and position of the jeans is determined by the relative orientation of the various rods, which are joined to each other by hinged joints to enable bending that is appropriate for a pair of jeans. More specifically, joints in the hip region enable spreading apart of the left leg from the right leg, and joints in the knee region enable bending of the legs at the knee location.

A multitude of inflatable bladders are affixed to the rods, that can be inflated by with variable volumes, pressures, and types of gases including air, inert gases, etc., to fill the jeans with a predetermined shape as well as providing other capabilities such as drying and wrinkle reducing or other using these gases for other processing needs. This enables the mounting system to accommodate different sizes and styles of jeans. For example, skinny-leg jeans may require less inflation of bladders in the calf and thigh regions then curvy-cut jeans. Another embodiment involves the use of pressure sensors within the bladders and the use of these sensors in order to enable monitoring the flow rate of gases into these bladders. These sensors enable a feedback system by which the bladders may be configured to exert a predetermined force on the fabric, or to inflate to predetermined volume, to ensure consistent stretching of the fabric. This enables fabrics with different elasticity be mounted on a single mounting station without loss of measurement accuracy or repeatability. Individual bladders can be inflated to different sizes and configured to exert different pressures, such that many different garment styles are accommodated by use of a single mounting apparatus.

Jeans are either mounted and unmounted by human workers, or may be mounted by a robotic system. This technique also includes various calibration objects (240) that are affixed to the mounting apparatus but that do not hinder the configuration of the jeans. These can include objects of known size or orientation relative to the mounting apparatus, or objects with specific surface properties. Reference objects are included for optical scanning to aid in processing of the scan-data by providing known objects for comparison with the jeans being measured.

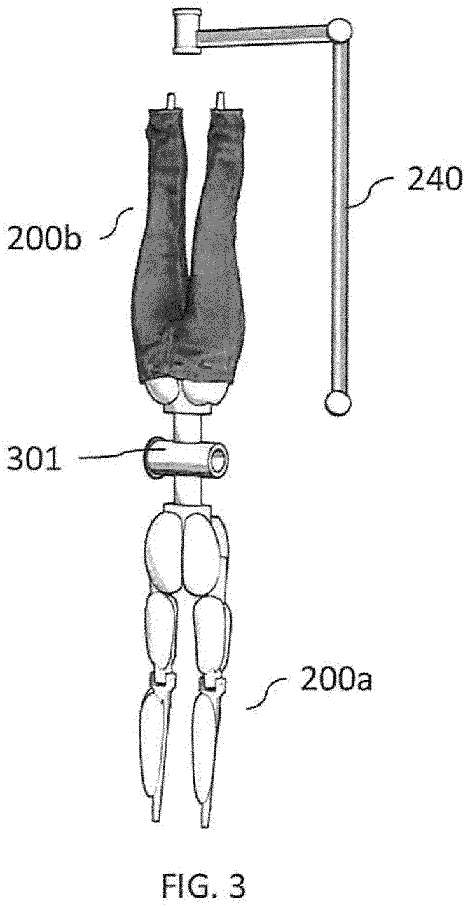

In addition, throughput (the speed at which measurements of the apparel is made while manufacturing is ongoing) is a major consideration of the system. If the relative scan time is shorter than, or comparable to, the mounting time, the throughput is increased by the ability to mount multiple garments on different positions on each mount. In one example as shown in FIG. 3, a single mounting apparatus comprises two mounting areas (200) located on opposite sides of a rotatable mounting system (310). One such mounting area (200a) is positioned for optical scanning while the other (200b) is positioned for mounting/unmounting of the jeans. This example enables a pair of jeans to be optically scanned while the previous pair is unmounted and a subsequent pair is mounted. Once scan-data from a pair of jeans is acquired, the rotatable mounting platform (301) rotates 180° to enable optical scanning of the next (other) mounting location. Furthermore, although not included in the figure, more than two mounting stations may be used to enable different types of moving assembly lines. For example, multiple mounting stations (200) can be positioned on a rotating carousel, with different activities occurring at different location. These activities include: mounting or unmounting; configuring garments into predetermined orientations or shapes via inflation of the bladders and/or motion of the rods; affixing stickers or markers in predetermined locations; scanning; affixing labels according to information obtained from scanning; and performing other manufacturing steps. These steps may be unrelated to scanning, or may be dependent upon information obtained from scanning, e.g. repositioning features, such as pockets, to correct manufacturing defects. Conveyer systems, where multiple mounting apparatus systems (200) are conveyed along pathways are also possible.

In another embodiment, the mounting system is adapted from a system used for another purpose during the manufacture of the apparel. For example, multiple pairs of jeans are mounted, in the normal course of existing manufacturing methods, upon automated, or semi-automated, rigs that position the jeans for application of laser texturing procedures, or for automatic dewrinkling/ironing/pressing procedures via the introduction of compressed steam. Such mounting systems are adapted such that the jeans can be configured in a stationary orientation on an “as required” basis for subsequent scanning. This technique enables scanning to be performed at the same station as for already existing manufacturing procedures and eliminates the need for an additional manufacturing step.

Scanning

Another aspect of the present invention is optical scanning by which scan-data is acquired. Optical scanning includes methods by which three-dimensional data may be acquired from the object being scanned, and may also include the acquisition of other surface properties. This disclosure provides for a robust optical scanning methodology that enables accurate, repeatable, and reproducible scan-data to be acquired. With reference again to FIG. 1A, the optical scanning procedure (120) may include scan resolution that acquires scan-data which represents the apparel with sufficient spatial resolution so that the necessary accuracy, repeatability, and reproducibility within the necessary tolerances of the measurements are achieved. The required resolution is dependent upon the particular object-information that is to be derived from the scan-data, and also upon the intended use for the scan-data. Optical scanning may be automated with minimal human intervention. For example, after installation and configuration of the system, a typical worker would simply need to start the process and then perhaps subsequently stop the process in the event that a safety-related situation requires the process to be interrupted.

This scenario is accomplished using optical scanning techniques that enable simultaneous extraction of three-dimensional data from the entire object, or the entire object within the scanning field of view. One such optical scanning technique is structured light, which is the process of projecting a known pattern (e.g., grids, horizontal bars, or interference patterns) onto a scene or object. How these patterns deform when striking surfaces allows vision systems to calculate the depth and surface information of the objects. Multiple images can be collected with a structured light or laser scanner system (or a multiplicity of systems) and “stitched” together to render larger images, but any given image is capable of being used to calculate three-dimensional information within its given field of view. For example, a complete point cloud for the entire field of view may be constructed from an individual image acquired using a structured light technique.

Other optical scanning techniques, such as laser reflectometry methods including LIDAR, time domain reflectometry, or frequency domain reflectometry, provide for nearly instantaneous three dimensional location information of a given object point, and a complete object image is constructed by translating the measurement system over the object and obtaining a location point cloud representative of the object. However, in these reflectometry scanning systems, each three dimensional location (represented by a single point in the point cloud) is acquired individually from a particular measurement. Such measurements are combined to build the full point cloud of the entire field of view of the reflectometry scanning device. As such, errors in determining a location compared to other locations on an object increase with distance between points. In addition, errors due to changes in the object surface (e.g. due to movement of a flexible garment) between measurements lead to reduced accuracy, reduced repeatability, and reduced reproducibility. Also, the use of triangulation from multiple images acquired from different vantage points relative to the object being measured, without including structure light, as has been tried by others in the past, suffers from similar disadvantages. For example, because multiple distinct images may be combined, any movement or alteration in configuration of the object being imaged between acquisition of multiple images will introduce inaccuracy. Furthermore, unless the mounting apparatus is designed in combination with the scanning technique, it is difficult to obtain a system suited to the unique challenges of positioning and repeatable measuring of flexible apparel.

Scanning considerations include one or more of various imaging technologies such as structured light, time-of-flight techniques, image triangulation and other image processing techniques. Various known software and software packages may be used for scanning and processing image data, including the three dimensional data of the present disclosure, such as for example:

MATLAB:

Polysoft

Geomagic (3D Systems, Rock Hill, S.C.)

Vxelemets

CAM2Inspect

It is understood that custom routines and scripts may be written with using some of these packages as a basis to extract the desired measurements.

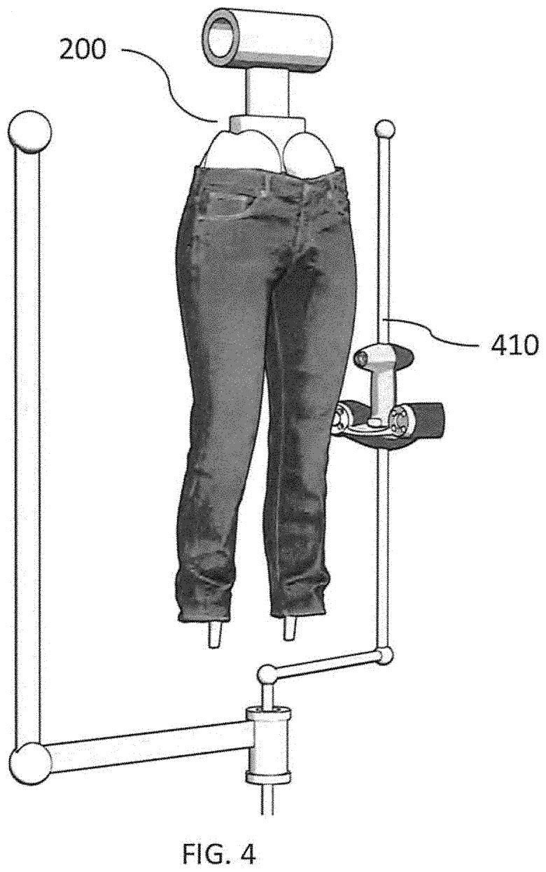

An example embodiment of one such optical scanning apparatus is shown in FIG. 4. The optical scanner is positioned using a robotic arm (410) and can be moved relative to the object being scanned to obtain scan-data for the entire object. Alternately, the optical scanner may be positioned in a fixed configuration and the mounting system (200) moves the object relative to the scanner to enable acquisition of scan-data for the entire object. Multiple optical scanners can be used to reduce or eliminate the need for relative motion between the scanner and the object being scanned as required for proper acquisition of scan-data from the entire object.

Features of the scanners includes the utility of one or more cameras and/or camera systems which are able to acquire images in one or more wavelength ranges. This includes variable wavelength filtering systems, variable polarization optics, and variable shuttering systems and use of coincident time-varying illumination patterns. Also, using mirrors and mirrored systems enables back portions of garments to be imaged simultaneously with the front portion; and utilizing lenses could expand or reduce the scanner's field-of-view as needed.

In addition, one or more lighting systems can be employed in connection with the scanners and associated cameras. This allows, for example, projecting light of known patterns onto the garment being scanned. Known physical separation between cameras or lighting systems that enable calculation of distance from the scanner may be employed on an as needed basis. The technology employed to assure success requires one or more systems for operating cameras in a coordinated way, such as simultaneous image capture, co-registration of images, known time-delays between cameras, etc., thereby alleviating the disadvantages present in systems that are unable to capture three-dimensional data from a single acquisition event.

Processing

Another aspect of the present disclosure is that scan-data received via optical scanning may be processed to extract object-information and is representative of the physical dimensions of the scanned apparel. This scan-data may also include additional information relating to essentially any accessible surface property of the apparel. The nature of scan-data and information included therein, as well as the nature and contents of the object-information derived from the scan-data, may be determined by requirements and considerations of the object being measured and the intended purpose for the information obtained from associated measurements.

For example, for the case of measuring a pair of jeans, scan-data may include a three dimensional point cloud that represents the complete physical geometry of the jeans and object-information derived therefrom. This includes any or all combinations of: the length of seams (e.g., the out-seam or inner seam), position, size, and shape of pockets, zippers, buttons, and other garment features; fabric surface area(s) and texture of selected regions; volumes of selected regions, such as leg or seat cavities; length of the waistband, etc. as well as measurement of other significant physical dimensions of the jeans.

As previously mentioned, the use of scan-data, such as a point cloud, and the processing of the data to obtain object-information that provides advantages over earlier methods of acquiring such measurement data is an aspect of this disclosure. For example, object-information which includes measurements taken of the actual length along the surface of a fabric between two points, rather than the linear distance calculated using Pythagorean techniques from two individual points, is one such example. A measurement for which this example is applicable is measurement of the out-seam on a pair of jeans. This measurement is the distance between the top of the waistband and the bottom of the leg hem. Existing methods of measuring this distance usually involves simply laying the jeans flat on a surface and then acquiring the linear distance of a straight line between a point on the waistband and a point on the hem, however this does not account for the curved nature of the human thigh region. Scan-data captures the curve of the leg and object-information derived therefrom is used to calculate the actual length of fabric along the out-seam. This process confers advantages over existing methods because different cuts or styles of jeans that have an apparent same linear out-seam measured with traditional methods might utilize different lengths of fabric. In addition, using and processing the scan-data as taught herein includes object-information to be derived which has been either impractical or impossible to obtain using earlier techniques. One example of obtaining such object-information is that of determining the volume of a garment cavity, such as a leg cavity, which in the past was at the least time consuming and cumbersome and in most cases impossible to measure. Another example of received and analyzed object-information is the determination of a given circumference of a garment cavity, such as a thigh circumference on a pair of jeans.

Processing techniques using geometric or numerical analysis methods applicable to the scan-data are included as a portion of this disclosure. Namely methods applicable to scan-data representative of three dimensional geometry, such as a point cloud, pre-processing, such as spatial averaging, or averaging between multiple scans, or Fourier based filtering techniques, applied to point cloud data to minimize the effects of noise of other unwanted data artifacts are additional techniques utilized for this system. Other pre-processing, such as orientating the scan-data according to a desired template or to discard spurious points far from the intended scan region are also included herein. Curves can be provided to correspond with point clouds along geometric features, for example: a parametric curve may be fit to the opening at the waist of a pair of jeans to extract the length of the waistband. In addition, curves may also be fit over any portion or region of the fabric surface between any two or more points located upon the surface. This method enables the length of these fit curves to be used to determine the distance between any pair of points within the surface of the fabric. This is in contrast to measuring the linear distance between any two points as would be obtained from Pythagorean calculations.

The coordinates of locations within selected regions can also be selected and processed using numerical techniques. For example: collections of points from a point cloud, or the entire point cloud, can be triangulated via meshing algorithms to generate a “meshed” object, this meshed object may then be objected to further analysis, such as the extraction of distances, or the extraction of coordinates of the surface that are not coincident with any of the points acquired in the point cloud. This is another example of a numerical analysis technique by which data is interpolated to fill gaps between acquired data points. Slices, or cross-sections, may be taken through the point cloud, or meshed objects can be generated from point cloud data to enable analysis of slices using two-dimensional image processing techniques. These techniques include object or group recognition, e.g. to location separated regions that constitute different legs in a slice through a pair of jeans as well as perimeter or edge detection, which is used to extract the perimeter or length around the objects in a given slice. Multiple slices can be used, such that data derived from the specific garment is separated into a series of slices, and then processed to enable image analysis methods to be applied to the entire garment. For example: a series of horizontal (perpendicular to the axis of the legs) slices may be taken through a pair of jeans and then the perimeter of the objects within all slices either combined or recombined to extract information regarding how the perimeter of the legs varies with distance from the hems.

In addition, machine vision techniques can be applied to scan-data, or during optical scanning, to enable automatic recognition of features of interest for use in data processing. For example, automatic detection of garment buttons, zippers, pockets, arms, legs, crotch, hem, or any other feature, can be performed to enable the locations of automatically detected features to be used in data processing. Such automatic feature detection includes detection of calibration objects utilized in the mounting apparatus. For example, automatic detection of rods of known size and orientation may enable calibration of length-scales and angles within the scan-data. With reference again to FIG. 1A, the data processing (130) and extraction of object-information is performed upon the scan-data automatically without human intervention. For example, features, objects, or regions of interest are automatically recognized by the processing software; also, appropriate processing techniques are automatically applied by the processing software so as to extract predetermined object-information. After initial installation and configuration of the processing software, typically there is no need for human intervention in the processing during normal optical scanning.

Scan-data and the object-information derived therefrom can be stored within a data storage system and/or one or more databases. With reference to FIG. 1A, storage of the data (140) is normally organized and may be able to provide scan-data, object-information, or both, for a particular scan upon request. Either entire scans and the associated data, or selected portions thereof, can be retrieved from the stored information. Stored data may be uniquely associated with the particular garment/apparel item from which it was obtained, which may necessitate the generation of meta-data upon acquisition, processing, or storing of data, e.g. a unique item-identifying numbers, along with other information such as batch-number, manufacture location/time, source of raw fabric, etc., may be associated with each set of scan-data or object-information. Such meta-data may facilitate use of the scan-data or object-information by enabling trends to be observed or correlations to be detected (150). For example, if a seasonable variation in final garment manufactured size is detected, or a correlation between the source of raw fabrics and the final manufactured size is desired/observed, appropriate adjustments to the manufacturing or labelling process could be performed and implemented to increase accuracy.

Whether scan-data, object-information from the scan-data, or both are needed to be stored, either in their entirety or in part can also be determined by the intended purpose for the information. Other practical considerations, such as data storage considerations, computing resources and time required to process scan-data into object-information, etc., need to be considered. For example, in cases where scan-data is large but the object-information derived is relatively small, it would be appropriate to store only the object-information if the database is not capable of handling large amounts of data. Those issues are quickly becoming irrelevant due to memory chips and associated micro-processing speeds increasingly growing in capabilities and capacities over the last decade and this trend regarding Moore's Law is continuing. Conversely, if the exact requirements for the object-information are not known at the time the scan-data is acquired, it may be appropriate to store the scan-data until such a time as it can be processed. Furthermore, the stored data may be organized in an appropriate manner to facilitate the intended use. For example, sets of scan-data, and object-information derived therefrom, may be stored in a database structure such that the metadata for all scans is indexed and searchable. The full scan-data or object-information for a given scan should be retrievable upon identifying a given data set via searching through the indexed metadata. In this example, the metadata may include information such as the time and location in which a set of scan-data was acquired, as well as information relating to the type of garment that was scanned. The metadata may be stored in a relational database and searchable via traditional means so as to enable, for example, selection of all scans that occurred in a given location, within a given range of times/dates and/or for a given variety of garment. Once these scans are identified, the corresponding scan-data may be retrieved for each scan from a non-relational data base. One example of such a non-relational database includes a system where the scan-data for many garments is stored in a key-value database. Each set of scan-data is associated with a key-value, such as a unique identification code, and these key-values are included in the metadata and used to look-up the appropriate sets of scan-data after key-values have been selected from the indexed and searchable metadata.

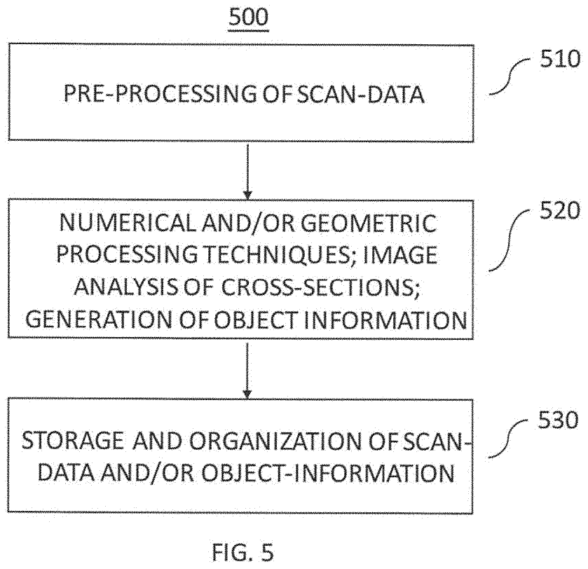

With reference to FIG. 5, the processing applied to one embodiment (500) may include pre-processing of the scan-data (510); followed by the application of a range of numerical and geometric processing techniques, as well as image analysis performed on cross-sections corresponding with the scan-data to generate the desired object-information (520); followed by storage of the pertinent data required to facilitate the purposes for which the optical scanning was performed (530).

Entire scans or portions of those scans containing data and data imagery are stored or extracted as needed depending on the system requirements. For example, to reduce data file sizes, only specific garment features or other apparel items on a per garment basis with minimal measurements may be stored, rather than storage of entire point-clouds and in some cases the massive amount of data (even streaming data) associated with those clouds. Storage and retrieval of data may be available for each unique unit of apparel and also may contain meta-data associated with data batch file number, manufacturing location, source of fabrics and other materials needed for assembly. The data may be provided on demand so that dimensional measurements associated with any of the required data can be instantly, reliably and reproducibly retrieved, analyzed and stored as needed. The data provides information utilized for any number of activities, including the control of apparel sizing and dimensions, development of new or existing apparel from source files, quality control during and/or after fabrication, etc. All of these activities are governed by stored data files that are available as required by employees and management. In this regard, it is useful to store the data using database software that resides on one or more computers, servers or other storage devices enabled by one or more computerized devices. In addition, it is often useful to provide the data via transmissions through or to an intranet or internet platform that is computer enabled so that remote analysis, control and feedback can be accomplished.

In another embodiment, purposes for which scan-data may be processed and applied include; comparison of the acquired data with an ideal set of data, labeling or categorizing garments according to any of the extracted parameters of physical properties including but not limited to; physical dimensions, color, texture, and also for quality control purposes.

More specifically, regarding the measurement of apparel, this disclosure includes the creation of scan-data representative of the physical dimensions of a given garment. This scan-data may then be processed, or combined with that acquired from other such garments and further processed, to create object-information from which standard patterns can be generated. These patterns are to be used in manufacturing apparel such as garments including pants, shirts, hats, gloves, and shoes. In this case, patterns are considered to be arrangements and/or shapes. In the case of apparel or garments, these patterns would include shapes of fabrics used to construct these garments. Garments manufactured from standard patterns can then be measured using the automatic garment inspection and measurement system to ensure that they meet quality control criteria, such as conforming within a desired tolerance for the intended physical dimensions.

Alternately, the initial step of scanning an original garment or collection of garments to generate standard patterns can be omitted, and garments can be designed using traditional tailoring methods in which the patterns for a given garment are created by a craftsperson or from a predetermined template created through other techniques including machine generated designs. Garments created from the resulting patterns can be scanned using an automatic garment inspection and measurement system and the resulting scan-data may be processed to obtain object-information that contains figures-of-merit that enable the manufactured garment to be compared with intended designs. For example, if the garment is a pair of jeans intended to include a specific waist size, then the scan-data is processed so that the resulting object-information contains the waist size as an included value. This enables the waist size of the manufactured garment to be compared to the intended value. Using this system, garments designed and manufactured using existing techniques can be measured using tolerance checking techniques that ensures their physical dimensions are satisfied.

In addition, for quality control purposes, detection of defects in size and dimensions that are not within tolerance requirements, or, for example, legs that are different in length by more than an acceptable tolerance may be considered. Detection of defects of quality, such as tears, unwanted marks/blemishes, unacceptable variation in color or fabric pattern is included as another aspect of this disclosure. The use of an appropriate user interface to enable observation of the object scans during the progression of the scanning is necessary as is user intervention when required (such as when programming a new scan routine or changing over to fabrication of different/new apparel).

The apparel, such as garments are categorized before, during, and after control of dimensional measurements used during fabrication. The scanning data is extracted as needed to assure that individual automated tasks are properly achieved using the equipment provide in the system (some of which is described below). More specifically, scan-data extracted includes for example, leg length that allows for a higher tolerance by the scan than by the target-length used during manufacture. More directly, a batch of nominally 76 cm leg-length trousers could be ordered from a short length, which may be 75 cm, up to the largest, which may be 77 cm, depending on the accuracy, precision, and degree of re-creation necessary for ease of fabrication. Garment apparel often are grouped by color, texture, etc. For example, differences required for dye “take-up” for different fabrics and during different manufacturing runs may be removed from entire fabrication runs to ensure saleable differences. Verifications of manufacturing tolerances are performed to categorize the apparel as being acceptable or unacceptable based on established criteria.

The necessary measurement precision extracted from the scan-data, e.g. the precision of values in object-information, will depend on the particular textile manufactured. For example, scan-data measurements of pant dimensions, such as length, waist, and thigh, may be less than 1″ off the actual, where actual is the dimension of the actual apparel item measured as would be obtained if an errorless measurement were possible. More preferably, the precision of scan-data measurements of pant dimensions are such that the error is reduced to within ⅛″ of the actual or smaller. The system including the mounting and scanning subsystems may produce scan-data with volumetric precision such that post-processing image analysis techniques produces this accuracy in the object-information. One simple method of estimating error is to assume that if you have measured values for each position along a length as quantities P₁, P₂, P₃, . . . Pₙ with uncertainties dP₁, dP₂, dP₃ . . . , etc., and if the final result, R, is the sum or difference of these quantities, then the uncertainty is dR=Σₙd Pₙ. An alternative method of estimating the error in the value of R is that dR=(Σₙ Pₙ)^{1/n}. Regardless of the method for estimating the combined error in many measurements, the error would increase with the number of values, n, in the calculation. Other techniques regarding estimating the needed accuracy of each volumetric point in the scan-data can be used and this example is not representative of the limits of the techniques that can be utilized and adopted for this system. The scan-data obtained may be accurate enough to account for cumulative errors in each point to obtain the desired object-data accuracy and reproducibility.

Further considerations include data (and the corresponding apparel) categorization and differentiation that includes the development of unique databases that store scanning data for each and every piece of apparel and/or garment. The database and accompanying software enable by a computerized set of machines and systems may include all scanning data from each individual scan as well as all figure-of-merit values extracted from each scan. Present day and future hardware and software integration using computational tools and associated computer equipment, storage size and capacity are no longer severely limited. As the costs of managing these data systems are increasingly reduced, the ability to access and manipulate large and useful amounts of data is less and less challenging. Point cloud data sets that are retrievable instantly or within short durations or even uninterrupted (such as streamed data), are also part of the inventive system described herein. All data including date, time and place of manufacture along with fabric, color, texture, etc. all may be entered either automatically by enhanced scanning, or during set-up of the process line. Yield and quality control are both aspects of extracting the scanning data as the process proceeds. This provides trends found to exist so that different fabrics manufactured to provide differently sized garments using the same or similar manufacturing parameters can be selected. This need occurs, for example, if a given fabric source undergoes more shrinkage during drying. When these trends arise from the analysis of, in this case, the shrinkage data, is possible to dynamically adjust the necessary manufacturing parameters to increase the yield of acceptable apparel.

One feature of the present disclosure is to provide a system or method for obtaining three dimensional data representative of an object being measured, consisting of an optical scanning system working in combination with a specific garment mounting apparatus. This technique is often described as “optical scanning” and includes any optical metrology process by which three-dimensional data representative of the object is acquired with one or more images captured on a point-by-point basis. More specifically, any given location of the object can be determined in one instance by image acquisition, as opposed to collecting multiple images temporally, or at multiple angles, and comparing the images to one another. Use of this technique alleviates subsequent processing challenges associated with unpredictable motion, vibration, and environmental artifacts.

Structured light is one process by which such three dimensional data is acquired from individual images. Structured light is the process of projecting a known pattern (often grids, horizontal bars, or interference patterns) on to a scene or object. How these patterns deform when striking surfaces allows for vision systems that calculate the depth and surface information of the objects. Multiple images can be collected with a structured light system (or a multiplicity of systems) and “stitched” together to render larger images, but any given image is capable of being used to calculate 3D information within a specific field of view.

Data acquired by optical scanning is referred to herein as “scan-data,” regardless of the exact methodology by which it is acquired. Optical scanning includes using light sources to transmit and receive optical signals from the objects requiring measurements. These optical signals are converted into “scan-data”. This scan-data is then utilized by the necessary equipment to provide information regarding accurate, precise, and reproducible images acquired from physical objects. In a sense, the scan-data provides a virtual representation of the actual apparel.

Another embodiment provides manipulation and processing of the scan-data in order to extract additional information from the data. Once extracted, this information extracted from the data is used for many purposes, including: quality control such as ensuring the dimensions of manufactured objects are within required tolerances of the values; recording to create a record of the information extracted from a given object; and sorting including labeling objects according to values or properties obtained from scan-data. Information extracted from scan-data is also referred to as “object-information.”

Another aspect of the system includes using scan-data acquired by optical scanning of an object that is representative of the physical dimensions of the object. In addition, the scan-data is also representative of surface properties of the object, such as color, transmittance, reflectance, emittance, surface texture, etc. One example of such scan-data includes utilizing a “point cloud” data collection system. A point cloud is a collection of points, each of which is associated with the x-, y-, and z-coordinate of a given point on the surface of the object being measured. Collectively, a point cloud at least provides a representation of the object that has been scanned by providing coordinates that define the surfaces of the object. The volumetric density of a point cloud determines the minimum feature size that can be accurately captured by the scan-data. In addition to providing physical coordinate data, from which dimensional and geometric information may be extracted, point clouds y also provide the local values of any other measurable property of an object surface. For example, each point can contain, in addition to x-, y-, and z-coordinates, data determined by the color, reflectivity, transmission, emittance, etc. of the corresponding location on the object surface. Although the above example use a Euclidean coordinate system with x-, y-, and z-axes, any applicable coordinate system may be used.

An additional embodiment includes a mounting system upon which an object is mounted or positioned as scan-data is acquired. The quality of scan-data, and the most suitable scanning method is combined with the mounting system to ensure that the complete system functions properly and is reproducible. Generally, an appropriate mounting system is required in order to acquire full and complete scan-data for a given object, and the particular mounting system to be used is determined by specific aspects of the object being measured. The mounting system may enable fast and convenient mounting/unmounting of objects to be scanned, and also may enable flexible objects to be held stationary in a predetermined configuration. For example, if the object being scanned is a pair of jeans, the mounting system may enable jeans to be loosely placed over the mounting system and then actuates to hold the jeans into a predetermined pose. This is accomplished by collapsible rod systems, or inflatable bladder systems, that can expand after jeans are mounted in order to fill the jeans and firmly hold the flexible fabric in a rigid configuration while optical scanning is performed. After scanning is complete, the rods collapse, or the bladder system deflates, so that the jeans are no longer firmly held and are easily removed from the mounting system without deformation or distortion.

Yet another embodiment includes storing the scan-data and object-information derived therefrom so that it can subsequently be used for a range of purposes including quality control; categorization of objects; accurate labeling of objects; inventory purposes; and optimization of manufacturing. The nature of scan-data and information included therein, as well as the nature and contents of the object-information derived from scan-data, is determined by specific requirements of the object(s) being measured and the intended purpose regarding the utilization of the data obtained from associated measurements.

One other aspect where this system may be used is for coloring fabrics and associated garments and apparel. For example, providing the specific and identical shade of white is a known difficulty that corresponds with matching pants with shirts in an all-white outfit problematic. Our system will greatly reduce and can, with proper continuous feedback loops, eventually eliminate this issue during several iterations of the process itself. Note, that for the purposes of color comparison, the present invention may benefit from being used in a manner appropriate for reliable color measurements: inclusion of a common color reference object within compared scans control of lighting during scanning, minimization of other variations regarding environmental factors, e.g. humidity, temperature, etc. All of these may alter the optical properties of the fabric. The ability to assign labeling to apparel based on scanning results and the associated storable and retrievable data provide previously unknown simplicity to the ability to identify and/or develop “smaller” or “larger” garments corresponding to a given size. It is also possible to identify actual colors and shades of garments accurately and label them accordingly.

While the present disclosure is specific for the inspection, measurement and fabrication of apparel and more specifically garments and clothing, there are several aspects of the specification and associated claims that allow for manufacturing or inspection of any object that may comply with detailed dimensional measurement requirements. Various modifications may be made to the embodiments described herein without departing from the spirit and scope of the invention as defined by the appended claims.

The present disclosure relates to at least the following aspects.

Aspect 1. An apparatus for measurement, inspection, and quality control during fabrication of apparel and apparel-related objects comprising:

(i) mounting equipment arranged to provide for full and unimpeded access of signals directed from any direction toward or away from said apparel and apparel-related objects;

(ii) scanning equipment that comprises scanning devices that scan said apparel mounted on said mounting equipment, wherein the scanning devices comprise any combination from the group consisting of optical, mechanical, and electrical scanning devices;

(iii) computer equipment capable of control of said mounting and scanning equipment, and wherein

said scanning equipment generates scan-data comprising signals obtained from said scanning devices that operate to provide at least 2 dimensional images that when combined are 3 dimensional images such that said scan-data is either sent or retrieved directly from said scanning devices and is stored and retrieved in and from one or more storage devices that reside on or in said computer equipment that provides for recognition, storage, and analysis of said scan-data, wherein said computer equipment includes scan-data storage, transmission, and analysis capabilities; and

wherein said scan-data contains and provides information necessary to determine and control apparel dimensions for complete inspection and fabrication to reduce or eliminate quality defects.

Aspect 2. The apparatus of claim 1, wherein said quality defects include unacceptable variations in stitching, breaks or changes in color or fabric patterns, tears, unwanted marks and blemishes.

Aspect 3. The apparatus any one of aspects 1-2, wherein said scan-data is digital data from signals generated and selected from the group consisting of electrical, electro-mechanical, electromagnetic, optical, mechanical, and magnetic energy.

Aspect 4. The apparatus of any one of aspects 1-3, wherein said scan-data is sent indirectly from scanning devices through one or more converters that converts one or more of electrical, electro-magnetic, optical, or mechanical data into digital data.

Aspect 5. The apparatus of any one of aspects 1-4, wherein specific information regarding said apparel and apparel-related objects contained within said scan-data is selected from any combination of the group consisting of videos, photos, and point-cloud imaging, wherein said point-cloud imaging provides parameters without distortion selected from any of the group consisting of automated manufacture, reproduction, quality control, and statistical analysis of said apparel.

Aspect 6. The apparatus of aspect 5, wherein said parameters are measurements without distortion selected from at least the group consisting of one or more of the following: dimensional shape, length, area, volume, diameter, circumference, lengths, area, surface texture, stretchiness, transparency, reflectivity, thermal transmittance, radiative transmittance, color, fabric type, and/or texture, and wherein said scan-data is received, stored and analyzed to achieve automated manufacture, reproduction and quality control of said apparel such that associated labeling and categorization occurs.

Aspect 7. The apparatus of any one of aspects 1-6, wherein said scan-data can be from scans selected from a group consisting of markers, pins, bar codes, IR codes, QR codes, and RFID tags.

Aspect 8. The apparatus of any one of aspects 1-7, wherein said computer equipment includes a server, wherein said server sends, stores and retrieves scan-data from and to a cloud-server.

Aspect 9. The apparatus of any one of aspects 1-8, wherein said computer equipment operates dependently and includes one or more computers capable of accessing one or more internet or intranet networks.

Aspect 10. The apparatus of any one of aspects 1-9, wherein said computer equipment includes one or more computers independently capable of retrieval, storage, and analysis of said scan-data and wherein said computer equipment provides at least one user interface to enable observation of scans during scanning that provides and allows for control of progression of scan-data.

Aspect 11. The apparatus of any one of aspects 1-10, wherein said computer equipment is networkable through use of a client-server and can operate as an enterprise network either independently, via an intranet, and/or via an internet including the world-wide-web.

Aspect 12. The apparatus of any one of aspects 1-11, wherein said scan-data is transmitted as uninterrupted data that may also be streaming data.

Aspect 13. The apparatus of any one of aspects 1-12, wherein said scan-data is stored and retrieved from a database, in that said scan-data is utilized to recreate images of said apparel in order to inspect, measure, and/or fabricate said apparel upon demand.

Aspect 14. The apparatus of any one of aspects 1-13, wherein said apparatus is dynamic in that said apparatus moves during said scanning and transmitting of said scan-data obtained from said apparel to said computer equipment.

Aspect 15. The apparatus of any one of aspects 1-14, wherein said scanning equipment and devices include programmable robots that take instructional information from software that accesses and interprets said scan-data residing in on or more data storage devices and wherein said robots act upon instructions from said instructional information to perform inspection, dimensional analysis, sizing, and fabrication operations.

Aspect 16. The apparatus of aspect 15, wherein said apparel is fabricated in an accurate, precise, and reproducible manner from robots utilizing said scan-data.

Aspect 17. The apparatus of any one of aspects 1-16, wherein said mounting equipment further comprises a mounting station designed specifically to hold said apparel such that features of said apparel are readily scanned using said scanning devices to ensure that said scan-data comprises information that is complete in that it provides accurate, precise, and reproducible images and associated information regarding said apparel.

Aspect 18. The apparatus of aspect 17, wherein said mounting station is static when used in conjunction with said apparatus in that said apparatus moves to ensure complete 2-D and/or 3-D scans during scanning and transmitting of said scan-data obtained from said apparel.

Aspect 19. The apparatus of any one of aspects 17-18, wherein said mounting station is dynamic in that said mounting station moves to ensure complete scans during said scanning and transmitting of said scan-data obtained from said apparel.

Aspect 20. The apparatus of any one of aspects 17-19, wherein said apparatus utilizes a lighting technology selected from one or more of the combination of: structured light, laser light, pulsed light, continuous wave light, and modulated light, that is transmitted and received from features existing on said mounting station, on said apparel, or on a combination of said mounting station and said apparel.

Aspect 21. The apparatus of any one of aspects 1-20, wherein said apparatus is automatically controlled either remotely or directly by said computer equipment with or without human intervention, and wherein automatic control allows for increased speed and efficiency during fabrication of said apparel.

Aspect 22. The apparatus of any one of aspects 1-21, wherein said apparel comprises garments.

Aspect 23. The apparatus of aspect 22, wherein said garments comprise articles of clothing.

Aspect 24. The apparatus of aspect 23, wherein said articles of clothing are selected from the group consisting of but not limited to pants, bags, jackets, shirts, undergarments, shoes, hats, coats, socks, and slippers.

Aspect 25. The apparatus of any one of aspects 1-24, wherein said apparatus is used to create a 2-D or 3-D representation to fabricate individualized or tailor-made clothing and wherein direct shipping via automatic control of fabrication is accomplished.

Aspect 26. The apparatus of any one of aspects 1-25, wherein said apparatus compares an object of a specified size to determine if dimensions of that object are within a predetermined tolerance of an ideal standard, further comprising imaging said object by scan and determination of a plurality of dimensions associated with said object and using scan-data to compare that scan-data with an ideal object and comparing dimensions of said object to standard dimensions for determining whether scanning dimensions of said object are within an allowable tolerance.

Aspect 27. The apparatus of any one of aspects 1-26, wherein said scan-data is obtained by fixing an object to a rotating mounting station, rotating said mounting station relative to an axis of rotation and capturing a plurality of images of said object such that each image captured from a distinct vantage point, and wherein said rotating mounting station is equipped such that said apparel is placed on a mount and inflated with gas so that said apparel assumes a desired shape and said mounting station is subsequently rotated to ensure full image capture is obtained.

Aspect 28. The apparatus of aspect 27, wherein one or more scans of said object provides complete scans by fixing said object to said mounting station and rotating a plurality of image capturing devices relative to said object and relative to an axis of rotation.

Aspect 29. The apparatus of aspect 28, wherein said complete scans are created by fixing said object to a rotating mounting station and rotating said mounting station so that a plurality of image capturing devices relative to each other and relative to an axis of rotation provide said scan-data.

Aspect 30. The apparatus of aspect 29, wherein said complete scans of said object are created by fixing said object to said mounting station and positioning a plurality of devices selected from any combination of the group consisting of: mirrors, cameras, and other optical or electro-optical devices around or on said mounting station, such that each of said devices are positioned at a distinct vantage point, thereby providing multiple image capturing devices in order to capture at least one scanned image of said object from each device during scanning and generating scan-data.

Aspect 31. A method for complete inspection, measurement, fabrication, and quality control of apparel, wherein said method comprises:

a) mounting said apparel using mounting equipment such that all features of said apparel are accessible and unimpeded by scanning equipment;

b) providing and enabling said scanning equipment in combination with said mounting equipment such that said scanning equipment is one or more of optical or electro-magnetic and is capable of providing scanning of said apparel thereby sending signals that comprise a form of scan-data utilized by one or more data storage devices residing within one or more computer systems;

c) organizing, storing, and retrieving said scan-data in order to develop accurate, precise, and reproducible images of said apparel; and

d) finalizing said method by providing information using a computer system capable of generating output comprising apparel inspection, measurements, and categorization of said scan-data.

Aspect 32. The method of aspect 31, wherein said data storage devices are databases.

Aspect 33. The method of any one of aspects 31-32, further providing a feedback loop so that said scan-data can be generated on a continuous basis and is being utilized to assure iteration toward achieving dimensional measurements that are identical or nearly identical to an ideal piece of apparel.

Aspect 34. The method of any one of aspects 31-33, wherein said computer system is networkable through use of a client-server and is operating as a network via an intranet, and/or via an internet including accessing and utilizing a world-wide-web.

Aspect 35. The method of any one of aspects 31-34, wherein said scanning equipment includes devices that are programmable robots taking instructional information from software that is accessing and interpreting said scan-data residing in or one or more databases, and wherein said robots are acting upon instructions from said instructional information to perform inspection, dimensional analysis, sizing, and fabrication operations on demand.

Aspect 36. The method of any one of aspects 31-35, wherein dimensional measurement information is being obtained from scan-data being transmitted in a form of digital imaging signals from said scanning equipment to said computer system during scanning of distinct features, said features are mounted directly to one or more of a portion of said apparel or to a mounting station holding said apparel.

Aspect 37. The method of any one of aspects 31-36, wherein said scan-data is being stored and retrieved from one or more data storage devices, wherein said data storage devices include relational databases, in that said scan-data is being utilized for organizing said scan-data and is being utilized to recreate images of said apparel for inspecting, measuring, fabricating, and reproducing said apparel upon demand.

Aspect 38. The method of any one of aspects 31-37, wherein said apparel is being fabricated in an accurate, precise, and reproducible manner from robots utilizing said scan-data.

Aspect 39. The method of any one of aspects 31-38, wherein said method is dynamic in that the method comprises moving a dynamic apparatus during scanning and transmitting of said scan-data obtained from said apparel by said computer systems.

Aspect 40. The method of any one of aspects 31-39, wherein said mounting equipment further comprises one or more mounting stations designed specifically for holding said apparel such that features are scanned using said scanning equipment and ensuring said scan-data comprises information that is complete in that it is providing accurate, precise, and reproducible images and associated information specific to said apparel.

Aspect 41. The method of aspect 40, wherein said mounting stations are static when being used in combination with dynamic apparatus in that said apparatus is moving thereby ensuring one or more of complete 2-D or 3D scans during scanning and transmitting of said scan-data obtained from said apparel.

Aspect 42. The method of any one of aspects 40-41, wherein said mounting stations are dynamic in that said mounting stations are moving to ensure completing one or more of 2-D or 3-D scans during said scanning and transmitting of said scan-data obtained from said apparel.

Aspect 43. The method of any one of aspects 40-42, wherein said method is utilizing a form of light selected from any one or combination of the group consisting of: structured light, laser light, pulsed light, modulated light, continuous wave light, and streaming light transmitted and received from features existing on said mounting station, on said apparel, or on a combination of said mounting station and said apparel.

Aspect 44. The method of any one of aspects 31-43, wherein said method is automatically controlled either remotely or directly by said computer systems with or without human intervention.

Aspect 45. The method of any one of aspects 31-44, wherein said apparel comprises garments.

Aspect 46. The method of any one of aspects 31-45, wherein said apparel comprises articles of clothing.

Aspect 47. The method of aspect 46, wherein said articles of clothing are selected from the group consisting of but not limited to pants, bags, jackets, shirts, undergarments, shoes, hats, coats, socks, and slippers.

Aspect 48. The method of any one of aspects 31-47, wherein said method is used to create a 2-D or 3-D representation generating individualized or tailor-made garments.

Aspect 49. The method of any one of aspects 31-48, wherein said method utilizes an apparatus comparing an object of a specified size to determine if dimensions of that object are within a determined tolerance of a standard, further comprising imaging said object by scanning and determining a plurality of dimensions of said object using said scan-data to compare that scan-data with an ideal object and comparing dimensions of said object to standards for determining whether scan-data dimensions of said object are within an allowable tolerance.

Aspect 50. The method of aspect 49, wherein said scan-data is obtained by fixing said object to a rotating mounting station and rotating said mounting station relative to an axis of rotation and capturing a plurality of images of said object, each image captured from a distinct vantage point, and wherein said rotating mounting station is equipped such that said apparel is placed on a mount and inflated with gas so that said apparel assumes its natural shape and said mounting station is subsequently rotated to ensure full image capture is obtained and resides in said scan-data.

Aspect 51. The method of aspect 50, wherein scanning said object provides complete scans by fixing said object to said mounting station and rotating a plurality of image capturing devices relative to said object and relative to an axis of rotation.

Aspect 52. The method of aspect 51, wherein said complete scans are created by fixing said object to a rotating mounting station and rotating said mounting station and a plurality of image capturing devices relative to each other and relative to an axis of rotation.

Aspect 53. The method of aspect 52, wherein scans of said object are being created by fixing said object to a mounting station and positioning a plurality of devices selected from the group consisting of mirrors, cameras, and other optical and/or electro-optical devices around said mounting station such that each of said devices is positioned at a distinct vantage point, thereby providing multiple image capturing devices in order to capture a scanned image of said object from each device during scanning and generating said scan-data.

Aspect 54. A system for measurement, inspection, and quality control during fabrication of apparel and apparel-related objects comprising:

(i) mounting equipment arranged to provide for full and unimpeded access of signals directed from any direction toward or away from said apparel and apparel-related objects;

(ii) scanning equipment that comprises scanning devices that scan said apparel mounted on said mounting equipment, wherein the scanning devices comprise any combination from the group consisting of optical, electrical, electro-mechanical, and electro-magnetic scanning devices that scan said apparel mounted on said mounting equipment;

(iii) computer equipment capable of control of said mounting and scanning equipment, and wherein said scanning equipment generates scan-data comprising signals obtained from said scanning devices such that said scan-data is either sent or retrieved directly from said scanning devices and is stored and retrieved in and from one or more storage devices that reside on or in said computer equipment capable of recognition, storage, and analysis of said scan-data wherein said computer equipment includes scan-data storage, transmission, and analysis capabilities;

and wherein said scan-data contains and provides information necessary to control and complete inspection, measurement, and/or fabrication of said apparel.

Aspect 55. The system of aspect 54, wherein said storage devices are databases.

Aspect 56. The system of any one of aspects 54-55, wherein said scan-data is digital data from signals generated using any form of energy selected from the group consisting of electrical, electro-mechanical, optical, mechanical and magnetic energy.

Aspect 57. The system of aspect 56, wherein said scan-data is sent indirectly from scanning devices through one or more converters that converts one or more of electrical, optical or mechanical data into digital data.

Aspect 58. The system of any one of aspects 56-57, wherein specific information regarding said apparel and apparel-related objects contained within said scan-data is selected from any combination of the group consisting of video, photo, emissivity, and point-cloud imaging, wherein said point-cloud imaging provides parameters necessary to ensure automated manufacture, reproduction, and quality control of said apparel.

Aspect 59. The system of aspect 58, wherein said parameters are measurements selected from at least the group consisting of one or more of the following; dimensional shape, volume, diameter, circumference, color, fabric type and/or texture and wherein said scan-data is received, stored and analyzed as required to achieve automated manufacture, reproduction, and quality control of said apparel.

Aspect 60. The system of any one of aspects 56-59, wherein said scan-data is obtained from two-dimensional generated data.

Aspect 61. The system of any one of aspects 56-60, wherein said scan-data is obtained from three-dimensional scan generated data.

Aspect 62. The system of any one of aspects 56-61, wherein said computer equipment includes a server, wherein said server sends, stores and retrieves scan-data from and to a cloud-server.

Aspect 63. The system of any one of aspects 56-63, wherein said computer equipment operates dependently and includes one or more computers capable of accessing one or more internet or intranet networks.

Aspect 64. The system of any one of aspects 54-63, wherein said computer equipment includes one or more computers independently capable of retrieval, storage, and analysis of said scan-data.

Aspect 65. A system comprising scanning equipment comprising one or more of optical devices or electro-optical devices that scan apparel, wherein scanning generates scan-data obtained from one or more of said optical or electro-optical scanning devices, and wherein said scan-data is digital and stored and retrieved in and from a database capable of recognizing digital data that resides on a computer system, said computer system includes storage and transmission capable of scanning data and wherein said scan-data contains and provides information necessary to complete inspection, measurement, fabrication, quality control and proper fit of said apparel, wherein said system is further configured for:

a) mounting said apparel such that selected features of said apparel are accessible by said scanning equipment;

b) acquiring and utilizing said scanning equipment, wherein said scanning equipment is also one or more of optical or electro-optical and is capable of providing scanning of said apparel thereby sending signals that provide scan-data to one or more databases residing within one or more computer systems;

c) organizing, storing, retrieving, and analyzing said data in order to develop accurate, precise, and reproducible images of said apparel; and

d) finalizing said system by providing said information using a computer system generating signals that form said scan-data wherein said scan-data comprises information including apparel inspection, measurements, and categorization.

Aspect 66. The system of aspect 65, wherein said system is further configured for providing a feedback loop so that said scan-data is generated on a continuous basis and is being utilized to assure iteration toward achieving dimensional measurements that are identical or nearly identical to an ideal apparel or apparel-related object is obtained.

Aspect 67. A method for measurement, inspection, and quality control during fabrication of apparel and apparel-related objects comprising:

(i) mounting equipment arranged to receive signals from a plurality of directions and/or sources;

(ii) scanning equipment configured to scan apparel and/or apparel-related objects disposed on the mounting equipment; and

(iii) computer equipment in communication with the scanning capable of control of mounting and scanning equipment, wherein:

the scanning equipment generates scan-data comprising three-dimensional images, and

wherein the computing equipment is configured to determine, based on the scan-data, three-dimensional apparel dimensions for inspection and/or fabrication to reduce or eliminate quality defects.

Aspect 68. The method of aspect 67, wherein the quality defects comprises variations in stitching, breaks or changes in color or fabric patterns, tears, unwanted marks and blemishes.

Aspect 69. The method of any one of aspects 67-68, wherein the scan-data is digital data from signals generated and selected from one or more of electrical, electro-mechanical, electromagnetic, optical, mechanical, or magnetic energy.

Aspect 70. The method of any one of aspects 67-69, wherein the scan-data comprises one or more of videos, photos, or point-cloud imaging.

Aspect 71. The method of any one of aspects 67-70, wherein the mounting equipment further comprises mounting stations designed to hold the apparel such that apparel features are readily scanned using the scanning equipment.

Aspect 72. The method of any one of aspects 67-71, wherein the apparel comprises garments.

Aspect 73. The method of aspect 72, wherein the garments comprise articles of clothing.

Aspect 74. A method for inspection, measurement, fabrication, and quality control of apparel, the method comprising:

a) mounting apparel using mounting equipment such that features of the apparel are accessible by scanning equipment;

b) scanning, using one or more of the mounting equipment and the scanning equipment, the apparel thereby sending signals that comprise a form of scan-data utilized by one or more data storage devices residing within one or more computer systems;

c) processing the scan-data in order to generate reproducible images of said apparel; and

d) generating, based on the reproducible images, output comprising apparel inspection, measurements, and categorization information.

What is claimed is:

1. A method for inspection, measurement, fabrication, and quality control of apparel, the method comprising:
a) mounting apparel using mounting equipment such that one or more select features of the apparel are accessible by scanning equipment;
b) scanning, using one or more of the mounting equipment and the scanning equipment, the apparel to generate scan-data from a plurality of perspective directions relative to the apparel;
c) processing the scan-data to generate reproducible images of the apparel; and
d) generating, based on the reproducible images, output comprising apparel inspection, measurements, and categorization information.

2. The method of claim 1, further comprising repeating steps a)-d) for at least one iteration, wherein the apparel is modified between iterations, and wherein the method facilitates reduction in quality defects of the apparel.

3. The method of claim 2, wherein the quality defects comprises variations in stitching, breaks or changes in color or fabric patterns, tears, unwanted marks and blemishes.

4. The method of claim 1, wherein the scan-data comprises digital based on signals projected onto the apparel.

5. The method of claim 4, wherein the signals comprise one or more of electrical, electro-mechanical, electromagnetic, optical, mechanical, or magnetic energy.

6. The method claim 1, wherein the scan-data comprises one or more of videos, photos, or point-cloud imaging.

7. The method of claim 6, wherein the apparel comprises a garment.

8. The method of claim 7, wherein the garment comprise an article of clothing.

9. The method of claim 1, wherein the mounting equipment is arranged to receive signals from a plurality of directions and/or sources.

10. The method claim 1, wherein the mounting equipment allows the apparel to be rotated during the scanning.

11. The method claim 1, wherein the scanning equipment comprises an optical scanning mechanism configured to output optical signals.

12. The method claim 1, wherein the generating output comprises comparing the reproducible images to stored reference images.

13. A system configured to implement the method of claim 1.
